(19) United States
(12) Patent Application Publication
(10) Pub. No.: US 2019/0253961 A1
(43) Pub. Date: Aug. 15, 2019

(54) METHODS AND DEVICES FOR SELECTING A COMMUNICATION INTERFACE

(71) Applicant: Orange, Paris (FR)

(72) Inventor: Bertrand Bouvet, Perros-Guirec (FR)

(21) Appl. No.: 16/308,252

(22) PCT Filed: Jun. 7, 2017
(86) PCT No.: PCT/FR2017/051435

§ 371 Date: Dec. 7, 2018

(30) Foreign Application Priority Data
Jun. 10, 2016 (FR) 1655375

(51) Int. Cl. H04W 48/18; H04W 24/08; H04W 36/14; H04W 36/30

(52) U.S. Cl. CPC H04W 48/18; H04W 24/08; H04W 88/06; H04W 36/30; H04W 36/14

(57) ABSTRACT

A method for automatically selecting a communication interface on a terminal. The terminal has at least a first wireless communication interface connected to a first access network and a second wireless communication interface connected to a second access network. The method includes obtaining a value representing the load of the first access network, selecting the first interface when the obtained value does not exceed a threshold, and establishing a communication through the selected interface.

### TECHNICAL FIELD

The present invention relates to the field of telecommunications and more particularly to a method for automatically selecting an access network that is optimal for establishing a communication from a mobile terminal.

### PRIOR ART

As the first 4th generation LTE (Long Term Evolution) mobile terminals are in the process of being deployed, operators are making available to users the first conversational services based on this technology. Thus, in this description the acronym VoLTE will be understood to mean the technology of voice transmission using LTE technology, and the acronym VxLTE will be understood to mean communication services in general based on LTE technology. Likewise, the acronyms VoWifi and VxWifi relate to the transmission of voice services over Wi-Fi and to communication services in general over Wi-Fi, respectively.

These new communication networks make provision for the transport of voice communications in packet mode, contrary to earlier technologies (GSM, RTC) in which voice communications were established in circuit mode. Communications are established through an IMS (Internet Multimedia Subsystem) network architecture. The standard makes provision for communications to be able to be established using various access networks. For example, a voice communication may either be established via a Wi-Fi access network or a 4G access network.

Terminals often provide relatively complicated configuring means the purpose of which is to allow users to choose the access network that is used, depending on the circumstances. For example, a user may configure his terminal so that it uses a Wi-Fi access point when he is at home and a 4G access network when he is out and about. Thus, terminals may be preconfigured by operators or users so that communications are established by way of a Wi-Fi network whenever it is possible to do so.

Terminals that have a user interface that allows the connection mode of the terminal that is to be preferred under given circumstances to be parameterized are known. For example, some terminals allow the user to specify whether he desires voice communications to be systematically established via Wi-Fi (VoWifi: Voice over Wi-Fi) or indeed systematically according to the LTE standard (VoLTE: Voice Over LTE) or indeed preferably via VoWifi when a network is available, etc. The user can also permit VoWifi communications only when a particular network is available. For example, a user may decide to permit VoWifi communications only when his home Wi-Fi network is available. These terminals have the drawback of requiring a complex and sometimes chancy configuration to be carried out.

Terminals capable of automatically selecting a Wi-Fi or LTE network depending on context information are also known. For example, certain terminals analyse the level of the radio signal in order to select the communication interface that is most likely to provide the best service quality. Thus, even if a user has indicated by configuration that he desires a VoWifi connection when a Wi-Fi network is available, the terminal may decide to use an LTE connection if the level of the Wi-Fi signal is below a preset threshold, and vice versa. This operating mode is however not entirely satisfactory. One drawback may in particular be felt when a communication is established with a shared Wi-Fi access point, such as for example a public access point.

Public access points, such as the Wi-Fi hotspots that various public establishments (such as airports, bars or restaurants) make available to their customers, are shared by many different users. When a particularly large number of users are using the access point, communications may be degraded even though the quality of the level of the radio signal is very high. Such a degradation is due to the load on the access network and not to the quality of the signal and generally leads to incomprehension on the part of the user who cannot understand why the communication is of poor quality given that the signal is of a good level. The user then has no choice but to end the communication and to reconfigure his terminal to force a new communication to be established via LTE.

Telecom operators have little or no control over Wi-Fi access points, which are most often the responsibility of the establishments hosting them. This is why the quality of communications is not guaranteed under these circumstances. There is therefore a risk that operators will see their customers choosing not to use VoWifi communications. However, use of Wi-Fi access points has a number of advantages for operators, because Wi-Fi access points allow the load on the cellular network, with which it is more expensive to establish communications, to be decreased and allow cellular coverage to be extended.

There is therefore a need for a solution that would make it possible to guarantee that a Wi-Fi access network is selected by a terminal only if it will allow communications of good quality to be established.

### SUMMARY OF THE INVENTION

To this end, the invention relates to a method for automatically selecting a communication interface of a terminal, the terminal comprising at least one first wireless communication interface connected to a first access network and one second wireless communication interface connected to a second access network.

The method is noteworthy in that it comprises the following steps:
obtaining a value representative of the load on the first access network,
selecting the first interface when the obtained value is not above a threshold, establishing a communication by way of the selected interface.

By virtue of the invention, an optimal network interface is selected depending on the actual load on the access network when a communication must be established. The expression “load on the access network” must here be understood to mean a value that is representative of the traffic currently being handled by the access network, and that is distinct from the quality of the radio signal. Specifically, the quality of a transmission via a Wi-Fi wireless network depends not only on the quality of the radio signal, but also on the load on the network, which varies independently of the signal level. Unlike a Wi-Fi access network, with which service quality is never guaranteed, a 2G/3G/4G cellular network possesses mechanisms for reserving resources (2G/3G) or prioritizing traffic (4G) depending on the services used, which allow overloading of the network to be avoided and the highest priority services to be delivered with a good service quality. In this case, only the quality of the radio signal is representative of how high the quality of a communication over the cellular access network will be. Thus, by virtue of the invention, if a user would prefer to establish a VoWiFi communication, for reasons to do with how much the communication will cost for example, the terminal permits the Wi-Fi communication only when the access network will allow a communication of correct quality.

The steps of the selecting method may be executed following the detection of a communication session request or prior to such a request.

According to one particular embodiment, the method is such that it furthermore includes, once the communication has been established via the first communication interface, the following steps:
determining a value representative of the quality of the established communication on the basis of received communication data, and
if the value representative of the quality of the communication is not above a threshold, switching the communication to the second communication interface.

Once a communication is in progress over a first communication interface selected using the automatically selecting method, the method according to the invention determines a value representative of the quality of the communication on the basis of the exchanged communication data. For example, the method may use the sequence numbers of the packets to count the number of packets not received and to calculate a transmission error rate, or implement any other mechanism allowing errors or transmission delays to be quantified. When this representative value is above a preset value, the method switches the communication to a second communication interface. By virtue of the invention, a communication established via an access network providing a non-guaranteed service quality, such as for example a Wi-Fi network, is automatically switched to a communication network the service quality of which is guaranteed, such as a 2G/3G/4G cellular networks, when quality drops below a threshold.

According to one particular embodiment, the method is such that the value representative of the load on the first network is determined at least on the basis of the idle-period density measured for the network.

As is known, Wi-Fi access points and terminals listen before emitting a data frame so as to avoid collisions when the frame is emitted, each terminal and/or access point using random periods to emit once there is no traffic.

The idle-period density is representative of the activity on a network. Thus, it is possible to deduce a load on the network if a low idle-period density is measured. Such a criterion is thus particularly relevant to whether or not a network interface is selected.

More particularly, a Wi-Fi terminals that wants to emit data listens to the network. If the network is busy, the transmission is delayed. In the contrary case, if the medium is free for a given time, then the terminal may emit. To do this, it emits an emission request containing information on the volume of data that it wants to emit and its transmission speed. The access point acknowledges reception of this message and the terminal starts to emit. The other terminals wait the time that they believe is required for the volume of information to be emitted to be transmitted at the speed indicated.

According to one particular embodiment, the value representative of the load on the first network is determined at least on the basis of an idle-period distribution in a time window.

A regular distribution of idle periods allows packets of communication data to be regularly sent. It is necessary, to achieve a communication of good quality, to regularly send communication data and in particular audio data. The method thus allows the quality of a communication established over a particular access network to be reliably estimated.

According to one particular embodiment, the load on the first access network is determined at least on the basis of the collision rate of the data frames exchanged over the first network.

As is known, the higher the load on a communication network, the higher the rate of collisions between the frames exchanged by the various devices using the network. The invention proposes to take advantage of this correlation to determine a value representative of the load on the network.

According to one particular embodiment, the first interface is furthermore selected depending on a value representative of the quality of the radio signal emitted by an access point to which said interface is connected.

Combined with a datum representative of the load on the network, a datum representative of the quality of the radio signal allows an interface that will allow a communication of good quality to be obtained to be reliably selected.

According to one particular embodiment, the step of obtaining a value representative of the load on the first access network comprises a step of obtaining a value representative of the load on a first leg of the access network and a step of obtaining the load on a second leg of the access network.

Such an arrangement for example allows a terminal to determine the load on an access network on the basis of the load on a Wi-Fi access point and of the load on an ADSL network to which the Wi-Fi access point is connected. In this way, the method advantageously makes it possible to prevent an access network from being selected on the basis of the load on a first leg when the load on a second leg is such as to make it impossible to establish a communication of good quality.

According to one particular embodiment, the method is such that the first network is a Wi-Fi network and the second network is a cellular network.

Thus, the invention is particularly suitable for being implemented in a terminal having both a communication interface suitable for establishing communications via a cellular access network, such as for example a 3G or 4G communication interface, and a communication interface suitable for establishing communications via an access network the quality of which is not guaranteed, such as for example a Wi-Fi access network. Such an arrangement is particularly advantageous for telecom operators who may thus encourage their users to make calls via an available Wi-Fi network rather than via a cellular access network. Specifically, the cost to the operator of a communication established via a Wi-Fi access point is much less than a communication established via a cellular access network. However, an operator is able to encourage a subscriber to privilege use of a Wi-Fi network only if the service quality is comparable to that obtained using a cellular network. Since Wi-Fi networks are only selected when the load on the latter allows communications of good quality to be established, the user is guaranteed to obtain a satisfactory service quality.

According to one particular embodiment, the method includes a step of displaying an indication representative of the load on the network on a screen of the terminal.

Conventionally, the load on a communication network to which a terminal is connected is not represented visually. Only an indicator of the quality of the radio signal is shown. The user of such a terminal cannot therefore select a network interface the load of which is compatible with the establishment of a communication of good quality. Advantageously, the invention thus allows a user to select one of the communication interfaces that will be most likely to allow a communication of good quality to be established.

According to one particular embodiment, the method is such that the indication representative of the load on the network is given by the color of a symbol representative of the quality of the radio signal.

According to one particular embodiment, the indication of network load is represented by a variation in the color of an indication of the quality of the radio signal. For example, the quality of a radio signal is conventionally represented on a screen in the form of a certain number of bars. The invention proposes to color the display of this symbol with one of three colors representative of the traffic being handled by the network. For example, an indication representing a single bar of green color may be used to indicate a weak radio signal and a network that is not saturated. In contrast, an indication representing a plurality of red bars may be used to indicate a good radio signal and a saturated network. Such a presentation combined with information on the quality of the signal and on the network load has the advantage of occupying very little space on the screen of a terminal.

According to one particular embodiment, the method is such that it furthermore comprises, once the communication has been established by way of a communication interface, a step of displaying an interface element suitable for performing a switch of the communication to an alternative communication interface when the value representative of the load on the network associated with the alternative interface is not above a set threshold.

Once a communication has been established and when an alternative access network is available, the method according to the invention proposes to determine the load on the alternative network. When the determined load on this access network is not above a set threshold, an interaction element is displayed on an interface of the terminal. For example, a button is displayed or activated on a touch interface of the terminal. An interaction of the user with this interface element then causes the communication to switch to the alternative network. In this way, the user may decide whether or not to change access network during a communication, but only when the conditions on the destination network are compatible with a communication of good quality.

According to another aspect, the invention relates to a device for automatically selecting a communication interface, the device comprising at least one first wireless network interface that is connected to a first access network and one second wireless network interface that is connected to a second access network, the device being characterized in that it comprises:
a module for obtaining a value representative of the load on the first access network,
a module for selecting the first interface when the obtained value is not above a preset threshold,
a module for establishing a communication by way of the selected interface.

The invention also relates to a terminal comprising an automatically selecting device such as described above.

The invention also relates to a computer program including instructions for executing the steps of the automatically selecting method, when said program is executed by a processor.

Lastly, the invention relates to a processor-readable data medium on which is recorded a computer program comprising instructions for executing the steps of the automatically selecting method.

The data medium may be any entity or device capable of storing the program. For example, the medium may include a storing means, such as a ROM, for example a CD-ROM or a microelectronic circuit ROM, or even a magnetic recording means, for example a floppy disk or a hard disk. Furthermore, the data medium may be a transmissible medium such as an optical or electrical signal, which may be conveyed via an optical or electrical cable, by radio or other means. The program according to the invention may in particular be downloaded over the Internet. Alternatively, the data medium may be an integrated circuit in which the program is incorporated, the circuit being suitable for executing or for being used in the execution of the method in question.

The various aforementioned features or embodiments may be added independently or in combination with one another, to the steps such as defined above of the improving method.

These terminals, devices, programs and data media have at least analogous advantages to those provided by the methods, described above, to which they relate.

According to another aspect, the invention relates to a method for transmitting, with a network access point including at least one interface with a network downstream of the access point and one interface with a network upstream of the access point, a value representative of the load on the network downstream of the access point, the method being such that it includes the following steps:
obtaining a value representative of the load on the downstream network,
transmitting the obtained value to a terminal connected to the upstream network, the terminal being suitable for automatically selecting a communication interface for establishing a communication at least on the basis of a value representative of the load on the obtained downstream network.

The transmitting method thus allows a terminal connected to the network upstream of an access point to obtain a value representative of the load on the downstream network. In this way, when the transmitting method is implemented for example by a residential gateway connected downstream to an ADSL network and upstream to a Wi-Fi network, a terminal connected to the Wi-Fi access network may obtain a value representative of the load on the ADSL network and the load on the Wi-Fi network. The terminal may then select the network interface that is best for establishing a communication, taking into account the various legs between it and the communication network.

According to one particular embodiment, the transmitting step is carried out by sending a DHCP message comprising a value representative of the load on the downstream network.

Thus, a terminal connected to the downstream network may obtain a value representative of the traffic during its attachment to the network or following a renewal of the DHCP lease or during a communication-establishment detecting phase or indeed even during communication.

According to one particular embodiment, the transmitting step is carried out by sending a push notification to the terminal.

Most mobile-terminal operating systems support what are called “push” notifications. It is a question of notifications emitted by a server and received by the terminal via various communication means. Such notifications are thus particularly suitable for a transmission of information to mobile terminals.

According to yet another aspect, the invention relates to a transmitting device, including at least one interface with a network downstream of the device and one interface with a network upstream of the device, able to transmit a value representative of the load on the network downstream of the device, the device being such that it comprises:
a module for obtaining a value representative of the load on the downstream network,
a communication module suitable for transmitting the obtained value to a terminal connected to the upstream network, the terminal being suitable for automatically selecting a communication interface for establishing a communication at least on the basis of the obtained value representative of the load on the downstream network.

The invention also relates to a network gateway comprising a transmitting device such as described above.

The transmitting device and gateway have at least analogous advantages to those provided by the transmitting method described above.

### LIST OF THE FIGURES

Other features and advantages will become apparent on reading the description of preferred embodiments, which is given with reference to the figures, in which:

FIG. 1 illustrates an architecture suitable for implementing the selecting method according to one particular embodiment of the invention,

FIG. 2a illustrates the main steps of the selecting method according to one particular embodiment of the invention,

FIG. 2b illustrates the main steps of the transmitting method according to one particular embodiment of the invention,

FIG. 3 shows the architecture of a device suitable for implementing the selecting method according to one particular embodiment of the invention, and

FIG. 4 shows the architecture of a device suitable for implementing the transmitting method according to one particular embodiment.

### DETAILED DESCRIPTION

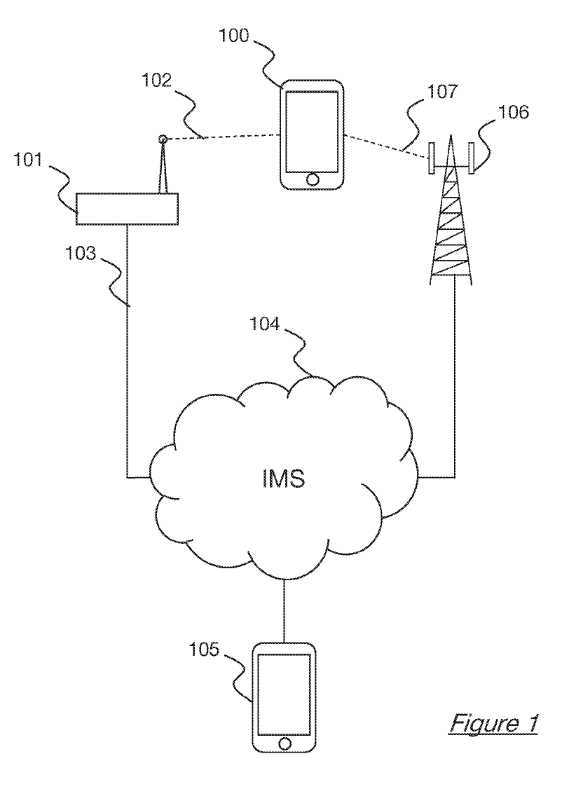

FIG. 1 illustrates an architecture suitable for implementing the selecting method according to one particular embodiment of the invention.

FIG. 1 shows a terminal 100 connected to an access point 101 by way of a wireless link 102. The terminal 100 is a communication terminal of the Smartphone type comprising at least two network interfaces allowing it to connect to in various ways to a communication network 104.

A first network interface of the terminal 100 is for example a Wi-Fi network interface suitable for connecting the terminal to the access point 101. Such an access point is for example an ADSL modem-router providing a wireless communication interface 102 of Wi-Fi type. The access point 101 also comprises a second communication interface 103, for example an ADSL (Asymmetric Digital Subscriber Line) interface, with a communication network 104. The network 104 is for example an IMS (Internet Multimedia Subsystem) network.

The terminal 100 may thus establish a communication with a second terminal 105 by way of the Wi-Fi connection 102, of the router-modem 101, of the ADSL network 103 and of the communication network 104. Such a communication established by way of the Wi-Fi access network is a VoWiFi communication.

The terminal 100 also comprises a second network interface. This interface is suitable for connecting the terminal to the communication network 104 by way of a second access network 106. The access network 106 is for example a 2G, 3G or 4G cellular network. The terminal may thus establish a communication with the terminal 105 via a connection 107 to the cellular network 106 and via the communication network 104. Such a communication is a VoLTE communication established over a 4G cellular access network.

Thus, the terminal may establish communications with the terminal 105 by means of either one of the network interfaces that it comprises.

The following description is given with reference to a voice communication, but the invention applies in the same way to other communication modalities, such as for example video communications or instant messaging. Likewise, although the present description is given with reference to an IMS communication network, the invention is in no way limited to this type of network and is suitable for various types of networks and/or communication protocols. Lastly, although the description takes as example a Wi-Fi access network 102, the invention applies to other types of access networks, such as for example Ethernet, WiMAX or Bluetooth access networks.

Conventionally, the network interface to be used to establish a communication may depend on preferences configured beforehand by the telecommunications operator. For example, an operator may preconfigure a terminal so as to privilege, when it is possible, VoWiFi communications, with the aim of decreasing costs and relieving the cellular network of traffic. Again according to the prior art, it is possible to choose the network interface to be used for a communication depending on a preference of the user, expressed either at the moment at which the call is made or via prior configuration of the terminal using a suitable configuration interface. For example, the terminal 100 may comprise configuration parameters allowing VoWiFi communications to be forbidden or forced, a VoWiFi or cellular communication to be preferred when the corresponding access networks are within range, or even cellular communications to be forbidden or forced when a network is available. Certain terminals automatically select a network interface depending on the quality of the radio signal. For example, a terminal may decide to establish a 4G VoLTE communication even though a Wi-Fi access network is available, when the radio signal of the Wi-Fi network is below a threshold.

However, such techniques do not always allow optimal selection of the network interface. In particular, techniques based on a measurement of the quality of a radio signal do not allow a good quality of communications over access networks without resource reservation, such as Wi-Fi networks, to be guaranteed.

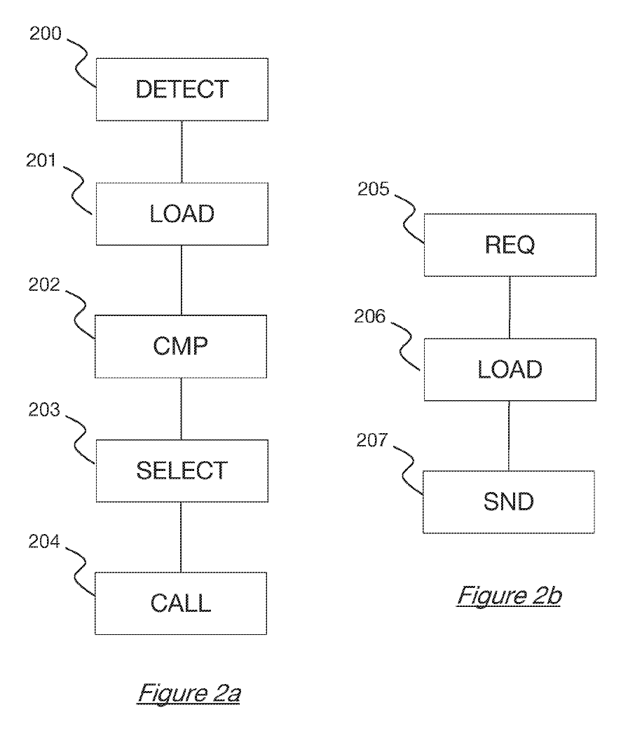

FIG. 2a illustrates the main steps of the method for automatically selecting a communication interface of a terminal. Such a method allows a terminal to optimally select an access network via which it may establish a communication when a plurality of access networks are available. With reference to FIG. 1, when it is a question of establishing a communication with the terminal 105, the method thus allows the terminal 100 to reliably determine which of the connections 102 and 107 is the most optimal.

To do this, in an optional step 200, the terminal detects a communication session request. The communication session request most often results from an action by the user, for example consisting in him inputting the identifier of a callee into a communication application and in him requesting, via an action on a user interface element, that a call be made. Such an action most often generates an event in the operating system of the terminal so that various services are able to detect the communication session request and to execute actions accordingly. For example, a call history of the terminal may subscribe to such a system event with the aim of detecting the destination, and the duration of a communication. Similarly, a terminal implementing the invention may detect a communication session request.

According to one particular embodiment, the terminal detects a communication session request originating from another terminal. For example, with reference to FIG. 1, the terminal 105 may send a communication session request to the terminal 100. The terminal 100 may then detect this session request by subscribing to a system event signaling an incoming communication.

When a communication is in progress, the detection then amounts to observing that a communication has already been established.

In step 201, the terminal attains a value representative of the load on the first access network. The load on the network here corresponds to a ratio between the actual traffic on the access network in question and the maximum theoretical amount of traffic that it is able to handle. The load on the network is a piece of information that is different and independent from the quality of the radio signal.

In order to estimate the load on the access network 102 and to obtain a representative value, the terminal may, according to one particular embodiment of the invention, examine the collision rate of data frames on the first network. Specifically, the greater the traffic on a wireless network, the higher the risk of collision between various data frames. Collisions are generally detected by wireless or Ethernet network interfaces so as to allow data that were not able to be transmitted correctly following a collision to be retransmitted. Thus, the terminal may interrogate a network card by means of an API (Application Programming Interface) provided for this purpose, and obtain in return a value representative of the load on the network to which this network card is connected.

However, certain data transmission protocols implement mechanisms the aim of which is to prevent collisions. The collision rate is then no longer a value representative of the load on such a type of network. For example, the protocol 802.11 implements the DCF (Distributed Coordinated Function) mechanism in order to avoid collisions.

According to one particular embodiment, the invention proposes to determine the load on an access network at least on the basis of the idle-period density on the first network. Specifically, a correlation between the number of idle periods per unit time and the actual load on the network may be observed. In particular, according to protocol 802.11, terminals connected to the access point listen before emitting data in order to avoid emission collisions. Each terminal or access point then uses random periods to emit once there is no traffic. The idle-period density may be obtained in the same way as the collision rate, by interrogating an interface device, such as a Wi-Fi network card, connected to the network.

However, it should be noted that a high idle-period density, for example corresponding to a moderate load on the access network, is not enough to guarantee a voice communication of good quality over the access network. Specifically, real-time video or voice communications require data packets to be regularly sent. For example, an audio communication may require data packets to be sent every 20 ms. According to one particular embodiment, the invention proposes to obtain a value representative of the distribution of idle periods in a preset time window in order to select an access network that is optimal for establishing a communication. Such a value may be obtained by examining the occurrences, the duration and the distribution of idle periods in a preset time window. The data allowing this value to be obtained may for example be obtained by interrogating, by way of an API provided for this purpose, an interface card used to interface with the access network. By making provision to match idle-period duration and distribution with data-packet size and emission frequency, the method according to the invention allows the quality of a communication over a particular access network to be reliably estimated.

According to one particular embodiment, the step 201 of obtaining a value representative of the load on the first access network comprises a step of obtaining a value representative of the load on a first leg of the access network and a step of obtaining the load on a second leg of the access network. For example, with reference to FIG. 1, the terminal 100 may obtain a value representative of the load on the legs 102 and 103. In this way, the estimation of the quality of a communication established via the Wi-Fi network 102 and ADSL network 103 is improved, and the selection of the network interface is optimal. The terminal may obtain the load on the network 103 by interrogating, for example, the modem-router 101 with an http request provided for this purpose. According to another particular embodiment, the modem-router 101 transmits information on the load on the network 103 by way of a suitable protocol such as for example the DHCP (Dynamic Host Configuration Protocol). The terminal may thus receive, in a DHCP message, information on the load on the downstream access network 103, either during its attachment to the access point 101, or after having transmitted a DHCP lease renewal request, or in a communication establishment phase, or during communication. The equipment 101 may however implement other mechanisms in order to communicate information on the load on the downstream network 103, such as for example a notification mechanism of the “push” type, such other mechanisms, as is known, being used to asynchronously transmit information to a terminal subscribed to the notification.

According to one particular embodiment, the device 101 implements the transmitting method such as will be described below with reference to FIG. 2b.

In step 202, the terminal compares at least one datum representative of the network load with a preset load value. Such a comparison aims to determine whether the network conditions allow a communication of good quality to be established. To do this, the terminal 100 compares the duration of any idle periods with the emission duration of the data packets and the distribution with the size and emission frequency of the data packets; the method according to the invention allows the quality of a communication established over a particular access network to be reliably estimated.

It will be noted that idle-period duration and distribution may be used by the terminal to determine an optimal coding format and/or an optimal packetization for the communication. For example, idle periods suitable for emitting frames of 20 bytes every 30 ms are not compatible with the use of the G.711 codec, whereas they are suitable for use of the G.723.1 codec.

At the end of the comparison, the terminal selects, in step 203, an optimal interface and establishes a communication in step 204. The selection of the interface may consist in configuring a communication module of the terminal so that the communication is established via the selected access network. The method according to the invention thus allows an access network that is optimal from the point of view of the quality of the communication to be selected.

According to one particular embodiment, an optimal access network is selected after a communication has been established. For example, if a VoLTE communication has been established between the terminal 100 and the terminal 105 by way of the access network 106 and the user is moving, so that the terminal comes within range of the access point 101, the terminal may decide whether it is advantageous to automatically change access network or, according to one particular embodiment, suggest this change of access network to the user. To do this, apart from the steps of the selecting method that were described above, the terminal may implement a step of estimating the quality of the already established communication. Thus, the decision to change access network is based not only on the characteristics of the traffic on the target access network, but also on the quality of the communication in progress over the first access network. The terminal may determine a value representative of the quality of the established communication on the basis of received communication data. For example, the terminal may detect effects that are indicators of poor network conditions such as jitter, delay or loss of a certain number of data packets. These data may for example be obtained by observing the data-packet sequence numbers or the number of samples missing during the decoding of the received data. The terminal may then decide to switch to another access network if the value representative of the quality of the communication thus determined is not above a threshold corresponding to a communication of poor quality, for example if the packet loss rate is higher than 2%, this rate depending on the codec implemented for the communication.

The switch to the target network may be carried out automatically when the quality of the established communication is poor and the value representative of the load on the target network promises a communication of good quality.

In order to further optimize the choice of an access network, the terminal takes into account, according to one particular embodiment, a value representative of the quality of the radio signal emitted by an access point to which said interface is connected. Conventionally, such a value corresponds to the power of the signal received by the terminal. Such a value decreases as the terminal gets further away from the access point. A weak signal may result in transmission errors and decrease the quality of the communication. The terminal 100 may thus interrogate the interface with the access network 102 by means of a suitable API, in order to obtain the power of the signal and to determine using the representative value the load on the same network 102, and decide or not to use the access network 102 to establish the communication.

Conventionally, the power of the radio signal is indicated by a symbol on the screen of telecommunication terminals such as the terminal 100. Such a symbol generally consists of a set of “bars” the number of which is proportional to the power of the received signal. Terminals display such a symbol in order to allow the user to evaluate beforehand whether it will be possible or not to establish a quality communication. However, as explained above, although an indication of the power of the signal remains necessary if the user is to be able to determine whether or not a network is within range, it is not enough to determine whether it is possible to establish a quality communication and to select an access network accordingly. Moreover, the screen of a mobile terminal is of limited size and the addition of an additional symbol for communicating to the user a value representative of the load on an access network is problematic. The invention provides a solution by proposing to color the radio-signal symbol depending on the value representative of the load obtained according to the method described with reference to FIG. 1. For example, when the radio-signal indicator is of red color and comprises all the bars, the user is notified that the signal is good but that the traffic on the network is such as to prevent communications of good quality. In contrast, a symbol of green color indicates that the traffic on the access network is not such as to prevent a communication of good quality. Various intermediate colors, such as yellow or orange, may of course be used in order to indicate intermediate levels of quality. The invention thus allows the technical problem of display of an additional piece of information on a screen of limited size to be solved and improves customer experience since customers do not need to correlate the meanings of a number of symbols themselves.

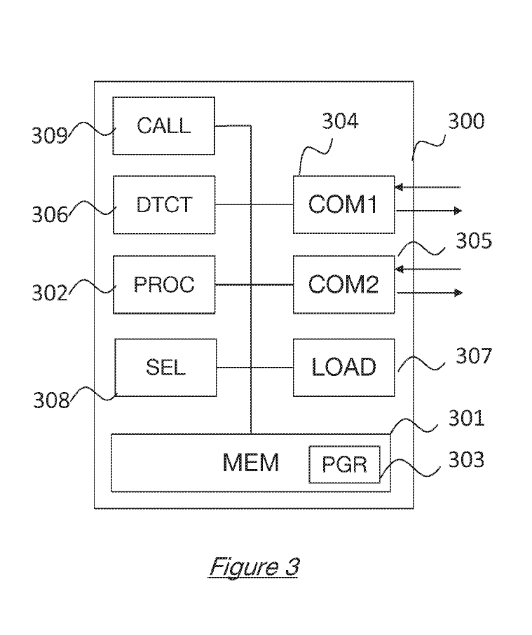

FIG. 3 illustrates the architecture of a device 300 suitable for implementing the selecting method according to one particular embodiment.

The device comprises a storage space 301, for example a memory MEM, and a processing unit 302 that is for example equipped with a processor PROC. The processing unit may be controlled by a program 303, for example a computer program PGR that implements the selecting method such as described in the invention with reference to FIG. 2a, and in particular the steps of obtaining a value representative of the load on the first access network, of selecting the first interface when the obtained value is not above a threshold and of establishing a communication by way of the selected interface.

On initialization, the instructions of the computer program 303 are for example loaded into a RAM (Random Access Memory) before being executed by the processor of the processing unit 302. The processor of the processing unit 302 implements the steps of the selecting method according to the instructions of the computer program 303.

To do this, the device comprises, apart from the memory 301, a communication module 304, such as a wireless network interface COM1, allowing connection of the device to and the exchange of data by way of a Wi-Fi access network. The communication interface 304 allows communications to be established with another terminal and messages and communication-data packets to be exchanged. The interface COM1 is furthermore configured to obtain information on the characteristics of the traffic over the access network to which it is connected, and in particular to determine at least a data-frame collision rate, an idle-period density or an idle-period distribution. According to one particular embodiment, the communication module 303 allows a DHCP message or a “push” notification comprising a datum representative of the traffic on a leg of a downstream network to be received.

The device also comprises a communication interface 305, such as for example a cellular network interface, suitable for establishing communications over a 2G, 3G or 4G cellular access network.

The device furthermore optionally includes a module 306 for detecting a communication session request. The module 306 may be a hardware or software module suitable for obtaining information on the system of the terminal with which a communication is on the point of being established. To do this, the module may subscribe, by way of an API, to system events relating to the establishment of communications so as to be notified when a communication is on the point of being established. In this way, the module 306 may detect a communication session request.

The device also comprises a module 307 for obtaining a value representative of the load on an access network. The module 307 may take the form of a computer program loaded into the memory 301 and executed by the processor 302. Such a program comprises instructions for interrogating a network interface of the terminal in order to obtain in return at least one value characteristic of the load on the access network.

The device 300 also comprises a module 308 for selecting an interface when the obtained value is not above a preset threshold. The module 308 may take the form of a computer program loaded into the memory 301 and executed by the processor 302. Such a computer program comprises instructions that are configured to compare a value representative of the load on an access network, which values are obtained by the module 307, and to select the access network when the result of the comparison is above a preset threshold.

The device 300 lastly includes a module 309 for establishing a communication by way of the selected interface. Such a module corresponds, according to one particular embodiment, to a circuit or a computer program comprising instructions configured to establish, when they are executed by the processor 302, a communication with a callee.

Such a selecting device may be integrated into a telecommunication terminal such as a mobile telephone, a smartwatch, a tablet or even a personal computer.

FIG. 2b illustrates the main steps of the transmitting method according to the invention. Such a method may advantageously be implemented in an access point such as the access point 101 shown in FIG. 1.

In an optional first step 205, the access point 101 receives a request originating from the terminal 100, the request comprising an indication according to which a value representative of the load on the network 103 is requested. Such an arrangement may for example be implemented by means of an http request sent by the terminal 100 to an http server integrated into the access point 101.

In step 206, the access point 101 obtains a value representative of the load on the ADSL network 103. This value may be obtained via the same arrangements as in step 201. According to one particular embodiment, the value is obtained, in the case of an ADSL access network, by comparing the value of the access line speed of the point 101 of access to the access network 103, which speed is obtained during start-up or resynchronization of the access point 101, with all of the up- and down-link traffic actually exchanged by or measured on the access network 103. The measurement of the load on the access network 103 may thus, depending on the technique used, take into account the case where a plurality of logic channels with different service qualities are used for various services (for example one logic channel for VoIP (Voice Over Internet Protocol) streams with an associated service quality, one logic channel for TV and/or VOD streams with an associated service quality, one logic channel for Internet streams with a “Best Effort” service quality, knowing that in this case the terminal 100 will use the Internet logic channel.

In step 207, the access point 101 transmits the obtained value to the terminal 100. The value may for example be transmitted in the response to the http request received in step 205. According to one particular embodiment, the obtained value is transmitted to terminals connected to the access network 102 by way of a DHCP message in which the value is contained in a new DHCP option dedicated thereto. According to one particular embodiment of the invention, the value is transmitted by means of a “push” notification to terminals that have subscribed to receive such a notification, the access point 101 integrating a push notification server that is itself able to be connected via the Internet to the push notification servers of various terminal suppliers (for example the “Apple Push Notification Server” of Apple™ or the “Cloud 2 Messaging” server of Google™) or indeed itself sending push notifications directly to the terminals, for example using WebSocket technology.

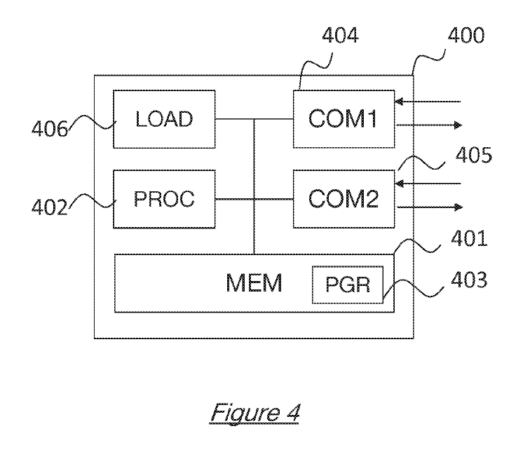

FIG. 4 shows the architecture of a device 400 suitable for implementing the transmitting method according to one particular embodiment.

The device comprises a storage space 401, for example a memory MEM, and a processing unit 402 that is equipped for example with a processor PROC. The processing unit may be controlled by a program 403, for example a computer program PGR that implements the transmitting method such as described in the invention with reference to FIG. 2b, and in particular the steps of obtaining a value representative of the load on the downstream network, and of transmitting the obtained value to a terminal connected to the upstream network, the terminal being suitable for automatically selecting a communication interface to be used to establish a communication at least on the basis of the obtained value representative of the load on the downstream network.

On initialization, the instructions of the computer program 403 are for example loaded into a RAM (Random Access Memory) before being executed by the processor of the processing unit 402. The processor of the processing unit 402 implements the steps of the transmitting method according to the instructions of the computer program 403.

To do this, the device includes an interface 404 with a network downstream of the device. The interface 404 may be a communication module such as an ADSL network interface suitable for exchanging data with other devices. The interface 404 is furthermore configured to obtain information on the characteristics of the traffic on the access network to which it is connected, and in particular to determine at least a data-frame collision rate if collisions can occur on the envisioned type of network, an idle-period density or an idle-period distribution.

The device also includes a network interface 405. The interface 405 is for example an interface with an upstream network. This upstream network is for example a Wi-Fi access network and the interface 405 is configured to play the role of a Wi-Fi access point. The interface 405 is also suitable for exchanging messages with other devices connected to the upstream network, and in particular to receive requests to be sent a value representative of the load on the downstream network. The module 405 is furthermore suitable for transmitting the obtained value to a terminal connected to the upstream network, the terminal being suitable for automatically selecting a communication interface for establishing a communication at least on the basis of the obtained value representative of the load on the downstream network.

The device lastly comprises a module 406 for obtaining a value representative of the load on the downstream network. Such a module has features and advantages that are similar to the module 307 described with reference to FIG. 3.

According to one particular embodiment, the device may comprise a DHCP server suitable for transmitting a value representative of the load on the downstream network to terminals connected to the upstream network.

According to one particular embodiment, the device may comprise a push notification server suitable for transmitting a value representative of the load on the downstream network to terminals connected to the upstream network.

The transmitting device may advantageously be integrated into a Wi-Fi access point, a modem-router, or a residential gateway.

1. A method comprising:
automatically selecting a communication interface of a terminal, the terminal comprising at least one first wireless communication interface connected to a first access network and one second wireless communication interface connected to a second access network, wherein the selecting comprises the following acts performed by the terminal:
obtaining a value representative of load on the first access network,
selecting the first interface when the obtained value is not above a threshold, and
establishing a communication by way of the selected interface.

2. The method as claimed in claim 1, furthermore comprising, once the communication has been established by way of a communication interface, the following steps:
determining a value representative of quality of the communication on the basis of received communication data, and
depending on the value representative of the network load and on the value representative of the quality of the communication, switching the communication to another communication interface.

3. The method as claimed in claim 1, wherein the value representative of the load on the first network is determined at least on the basis of the idle-period density measured for the network.

4. The method as claimed in claim 3, wherein the value representative of the load on the first network is determined at least on the basis of an idle-period distribution in a time window.

5. The method as claimed in claim 1, wherein the value representative of the load on the first access network is determined at least on the basis of a collision rate of data frames exchanged over the first network.

6. The method as claimed in claim 1, wherein the first interface is furthermore selected on the basis of a value representative of quality of a radio signal emitted by an access point to which said interface is connected.

7. The method as claimed in claim 1, wherein the act of obtaining a value representative of the load on the first access network comprises obtaining a value representative of load on a first leg of the access network and obtaining a value representative of load on a second leg of the access network.

8. The method as claimed in claim 1, wherein the first network is a Wi-Fi network and the second network is a cellular network.

9. The method as claimed in claim 1, further comprising displaying an indication representative of the load on the network on a screen of the terminal.

10. The method as claimed in claim 1, furthermore comprising, once the communication has been established by way of an access network, displaying an interface element suitable for performing a switch of the communication to an alternative access network when the value representative of the load on the network associated with the alternative access network is not above a threshold.

11. A device for automatically selecting a communication interface, the device comprising:
at least one first wireless network interface is connectable to a first access network;
at least one second wireless network interface that is connectable to a second access network;
a processor; and
a non-transitory computer-readable medium comprising instructions stored thereon, which when executed by the processor configure the device to perform acts comprising:
obtaining a value representative of load on the first access network,
selecting the first interface when the obtained value is not above a preset threshold, and
establishing a communication by way of the selected interface.

12. A method comprising:
transmitting, with a network access point including at least one interface with a network downstream of the access point and one interface with a network upstream of the access point, a value representative of load on the network downstream of the access point, wherein transmitting comprises:
obtaining a value representative of the load on the downstream network, and
transmitting the obtained value to a terminal connected to the upstream network, the terminal being suitable for automatically selecting a communication interface for establishing a communication at least on the basis of a value representative of the load on the obtained downstream network.

13. A device comprising:
at least one interface with a network downstream of the device;
at least one interface with a network upstream of the device;
a processor; and
a non-transitory computer-readable medium comprising instructions stored thereon, which when executed by the processor configure the device to transmit a value representative of the load on the network downstream of the device, wherein transmitting comprises:
obtaining a value representative of load on the downstream network,
transmitting the obtained value to a terminal connected to the upstream network, the terminal being suitable for automatically selecting a communication interface for establishing a communication at least on the basis of the obtained value representative of the load on the downstream network.

14. A network gateway comprising the device according to claim 13.

15. A communication terminal comprising the device according to claim 11.

16. A non-transitory processor-readable data medium on which is recorded a computer program comprising instructions, which when executed by a processor of a communication terminal configure the terminal to select automatically a communication interface of a terminal, the terminal comprising at least one first wireless communication interface connected to a first access network and one second wireless communication interface connected to a second access network, wherein the selecting comprises the following acts performed by the terminal:
obtaining a value representative of load on the first access network,
selecting the first interface when the obtained value is not above a threshold, and
establishing a communication by way of the selected interface.
